(19) United States
(12) Patent Application Publication
(10) Pub. No.: US 2013/0162430 A1
(43) Pub. Date: Jun. 27, 2013

(54) Method and System for Charging Mobile Devices

(71) Applicants: Shimon Scherzer, Ramot HaShavim (IL); Yariv Lifchuk, Rishon le Zion (IL); Tamir Scherzer, Herzelia (IL); Eran Naveh, Ramat-Gan (IL)

(72) Inventors: Shimon Scherzer, Ramot HaShavim (IL); Yariv Lifchuk, Rishon le Zion (IL); Tamir Scherzer, Herzelia (IL); Eran Naveh, Ramat-Gan (IL)

(73) Assignee: WEFI, INC., Tel Aviv (IL)

(21) Appl. No.: 13/589,938

(22) Filed: Aug. 20, 2012

Related U.S. Application Data
(60) Provisional application No. 61/524,877, filed on Aug. 18, 2011.

(51) Int. Cl. G08B 21/24

(52) U.S. Cl. CPC G08B 21/24
USPC 340/539.13

(57) ABSTRACT

A method and system for determining charging opportunities includes monitoring the location of a mobile device and the location of the mobile device when it is charging to develop a list or database of locations where the mobile device can be charged. The location can include that the mobile device is in a car or on a train, where the user can connect the mobile device to a power source to charge the device. After a list of charging locations is identified, the mobile device can determine whether the user is staying in a favorite location and after predefined period of time send an alert to the user to charge the device. The alert can be sent to the user before the device has reached the low battery threshold.

### CROSS-REFERENCE TO RELATED APPLICATIONS

This application claims any and all benefits as provided by law of U.S. Provisional Application No. 61/524,877 filed Aug. 18, 2011, which is hereby incorporated by reference in its entirety.

This application is related to U.S. application Ser. No. 11/441,827, filed on May 25, 2006, bearing Attorney Docket No. 048642-001000; U.S. application Ser. No. 11/853,987, filed on Sep. 12, 2007, bearing Attorney Docket No. 048642-006000; U.S. application Ser. No. 11/968,073, filed on Dec. 31, 2007, bearing Attorney Docket No. 048642-008000; U.S. application Ser. No. 12/180,159, filed on Jul. 25, 2008, now U.S. Pat. No. 8,126,476, issued Feb. 28, 2012 bearing Attorney Docket No. 048642-005100; U.S. application Ser. No. 12/549,784, filed on Aug. 28, 2009, bearing Attorney Docket No. 048642-013000; U.S. application Ser. No. 12/907,959, filed on Oct. 19, 2010, bearing Attorney Docket No. 048642-014000; U.S. application Ser. No. 13/362,554, filed on Jan. 31, 2012, bearing Attorney Docket No. 048642-021000; U.S. application Ser. No. 13/400,056, filed on Feb. 28, 2012, bearing Attorney Docket No. 048642-022000; Ser. No. 13/458,420, filed on Apr. 27, 2012, bearing Attorney Docket No. 048642-023000; and U.S. application Ser. No. 13/486,640, filed on Jun. 1, 2012, bearing Attorney Docket No. 048642-024000, each of which are hereby incorporated by reference in their entireties.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is directed to methods and system for charging battery operated mobile devices. More specifically, the present invention is directed to methods and systems for maintaining the charged state of the battery by reminding the user to plug in the device when the device detects that it is in a location where a charging opportunity is available.

2. Description of the Prior Art

As wireless terminals are becoming more powerful and complex, battery life is quickly becoming a limiting factor. More and more efforts are invested into reducing power consumption; in some cases power saving sacrifices user experience (lower screen brightness, shutting off applications etc.). Furthermore, most proposed methods rely on complex decision making based on questionable field conditions. For example:

Turning Wi-Fi radio on only in places Wi-Fi is likely to be used
Turning other radios in terminal based on expected traffic demand
Turning Wi-Fi radio off when screen if off, assuming no traffic demand terminal is on “standby”

Since the user (and their device) is most likely to be located in only few regular places during a normal day (e.g., home, office, recreational place, religious place, etc.) relying on a system designed to turn radios off when user is located in these places (many of which may have Wi-Fi) can do very little to help battery life expectancy. The value of decision based on highly variable conditions (mobility is always associated with unexpected conditions) is marginal at best. Consequently trying to push the energy consumption down based on complex decisions is not likely to have the desired impact on battery life.

The situation is similar to the auto industry: high performance cars usually consume more gas; one can save gas by giving up on performance and convenience by switching to a smaller, economical model—but most people do not. To compensate for high fuel consumption more and more gas stations are built, and they are well marked (large signs, alerting signs etc.). Drivers are enticed to stop at gas stations even if their gas tank is not empty: stores, discount signs, warning sign such as “last gas station until . . . ” etc. We are proposing similar approach to the mobile terminal “gas tank”—the battery.

In the prior art, most portable devices notify the user when the battery or other power source drops below a predefined level, prompting the user to plug the device into either a power adapter (e.g., connecting to AC power) or other charging station to charge the device. The problem with this approach is that in many situations a charging station or charging device is not available when users is being prompted.

### SUMMARY

In the prior art, most portable devices notify the user when the battery or other power source drops below a predefined level, prompting the user to plug the device into either a power adapter (e.g., connecting to AC power) or other charging station to charge the device. The problem with this approach is that in many situations the user is not in a location where the device can be charged or does not have the charger or other equipment needed to charge the device.

In accordance with some of the embodiments of the invention, if the user could look back and identify all the places that user visited prior to reaching the location where their mobile device needed to be charged, it is likely that there were places where the user could have charged or “topped off” the battery so that the battery would not need to be charged in a location where no charging ability is available (no power or no equipment). Further, the determination of when to present a charging alert can be controlled, so that the mobile device does not prompt the user with charging alerts so frequently that it becomes an annoyance, possibly causing the user to disables the feature. This can be controlled, for example, by only encouraging the user to charge their device when the battery level is below a predetermined threshold (e.g., below 75% or below 50%).

In accordance with some embodiments of the invention, the mobile device includes the capability to determine its location, either specifically (e.g., using Global Positioning System—GPS information) or more generally (e.g., using a wireless network service, such as cellular, 3G, 4G or WiFi location based services). Using this information, the mobile device can monitor and record in memory (e.g., a charging database), the location information relating to locations where the mobile device can be charged. During normal operation, the device can periodically determine whether the device is in a location where the device has been charged in the past, for example, by comparing the present location information to the charging database. If the location information matches or is close to a location in the database, the device can prompt the user to charge the device, even though the device has not reached the low battery state.

In accordance with the some embodiments of the invention, the prompt can be any audio or visual signal available on the device signal the user. The prompt can include one or more of the following: a pop-up message, a flashing symbol or message, a light (including a specific color, blinking pattern or combination thereof), a sound or vibration or a combination of prompts. In some embodiments, the prompt can be configurable by the user.

These and other capabilities of the invention, along with the invention itself, will be more fully understood after a review of the following figures, detailed description, and claims. To sum-up: the proposed method encourages users to charge battery when it is possible to do so instead of “when needed”.

### BRIEF DESCRIPTION OF THE FIGURES

FIG. 1 is a flow chart of a method for determining whether to send a charge notification to a user according to an embodiment of the invention.

FIG. 2 is a flow chart of a method for determining a user's favorite places according to an embodiment of the invention.

FIG. 3 is a flow chart of a method for determining whether to send a charge notification to a user according to an alternative embodiment of the invention.

FIG. 4 is a block diagram of a device according to the invention.

FIG. 5 is a block diagram of a system according to the invention.

### DETAILED DESCRIPTION OF PREFERRED EMBODIMENTS

The present invention is directed to methods and systems for charging mobile devices that includes identifying potential charging opportunities (e.g., situations where, based on available information, the mobile device can be charged.). Using information available to the mobile device, including location services and sensors, either alone or in combination with other information, such as time of day, day of the week and usage, the mobile device can prompt the user to charge the power source of the mobile device, even though the power source may not have reached the device's low power threshold.

The present invention is directed to methods and systems that facilitate charging the power source of a mobile device when the external power sources (e.g., AC outlets, USB ports and other power connections) are available. Unlike the prior art charging alert system that is based on battery getting to some minimum level and triggering an audio or visual alert to notify user (which can be useless in cases where charging is impossible due to lack of charging outlets or accessories), the present invention is directed to a method and system that notifies the user to charge the mobile device (as well as other less intelligent mobile devices) when charging outlets and/or accessories are available. In accordance with some embodiments of the invention, a “charging opportunity” is situation (such as a location or set of conditions) where a mobile device can be charged. In accordance with some embodiments of the invention, a charging opportunity can be identified based on information available to the mobile device, such as location, location history, device movement, or lack of device movement. For example, where a location information is available to the device, for example, from a GPS or WiFi location based service, the device can determine that it is in a home or hotel or some place where a user is likely to be able to plug the device into an external power source to charge it, representing a charging opportunity. In other example, the device can determine that it is not moving, that the user is stationary or has stored the mobile device (e.g., based on orientation information from the device), representing a charging opportunity. In accordance with some embodiments of the invention, a charging opportunity can be identified based on the devices movement, for example, traveling along a roadway or train tracks, indicating that the user is traveling in a motor vehicle or train, since many of these modes of transportation provide external power, they provide a charging opportunity. Similarly, if the user puts the mobile device in, so called, “airplane mode,” many airplanes provide charging outlets for mobile devices and provide a charging opportunity. In many of these situations, the user may choose to charge the device, but where the user is preoccupied, the device can remind or otherwise notify the user of the charging opportunity.

In some embodiments of the invention, the mobile device can collect the information and determine whether a charging opportunity is present. In other embodiments of the invention, the mobile device can collect the information and send it to a remote terminal or system which can determine whether a charging opportunity is present. In accordance with the invention, the remote system can use information that is not available to the mobile device to determine whether a charging opportunity exists.

In accordance with some embodiments of the invention, the device can identify or determine “charging opportunities” at strategic locations and notify users to exploit them. In time, the user can develop a habit of charging the device at these locations, without prompting (e.g., training the user). Potential locations where charging opportunities are likely to exist include the home, the office, shopping centers, restaurants and coffee shops, and airports (some airports already provide mobile device' charging stations, for example, by Samsung Corp and others).

The present invention can use data analytics to identify charging opportunities and subsequently notify users about them. The proposed solution can effectively extend battery life without modifying the battery itself.

We define charging opportunity as a situation where a mobile device can be connected to an external power source to charge an internal battery of the device. These opportunities can be automatically discovered and the user can be notified of the opportunity. As a result, the invention can be used to modify the behavior of the user. Over time, the device will consistently or regularly notify the user of the charging opportunities and such that user will remember to take advantage of the available charging opportunities before being notified by the system.

In accordance with some embodiments of the invention, charging opportunities can be determined as function of the conditions and location sensed by the sensors and other components (e.g., transceivers) of the mobile device. In one example, the conditions can include being in a specific place, for example, being at home, a work-place or any other location known to have the right conditions, e.g., available external power sources. In another example, the conditions can include being static for a period of time (e.g., indication of a location where external power is available, such as a home or work location). In another example, the conditions can include being horizontally laid down (e.g., on a desk—indication of a location where external power is available, such as a home or work location). In another example, the conditions can include whether the user charged the mobile device before at this location (indication that a power source is likely nearby). In another example, the conditions can include detecting lengthy breaks in data traffic activity at location (if PC is used, data traffic through mobile terminal is less likely) and a USB cable can be used for charging. In another example, the conditions can include continuous movement or movement over a known path (roadway or train tracks) may indicate traveling (e.g., commuting on a train or driving) so the user can charge the device in the car or on the train.

A charging opportunity can be determined as function of all or some of the information above, e.g., using a union of all or some of the information above. When a combination of the information above indicates high likelihood of existence of charging opportunity, the user can be alerted.

To avoid excessive messages to user, message generation can be conditioned to some pre-defined battery and usage conditions. For example, if battery is below 70% and most of the above components show high likelihood of charging opportunity, and terminal is not being charged, a charging alert can be sent to user. The charging alert or notification can be sent by SMS, email, on screen notification or any other indication to user.

### EXAMPLE I:

Office charging opportunity can happen when a user sits at his desk. Locating the user at his office can be done by identifying the Wi-Fi network; this network is determined to be the office network by the fact that it has been reported many times in working hours and user had the network Wi-Fi profile in his device.

In many cases the user puts his mobile terminal on his desk such that the terminal is perfectly stationary for lengthy period ad also it lies horizontally. This situation can be easily discovered by monitoring the built in orientation/movement sensors, and then generate a message to user suggesting to connect the device via USB cable to his laptop for charging.

In accordance with some embodiments of the invention, the system can register locations where charging had been done in the past; the location can be rather inaccurate (cellular based location) assuming that when said location is indicated, user will always be in same physical location. Consequently, when terminal start reporting the said location, software should wait some time (say 30 minutes) to allow user arriving at the “previously charging location”. After the said time period, if terminal battery status is below certain charge level, if charging has not initiated yet, software can generate a notification to user to charge the terminal. In addition, software can monitor the movements of the terminal and generate said notification only when terminal is static for certain time period.

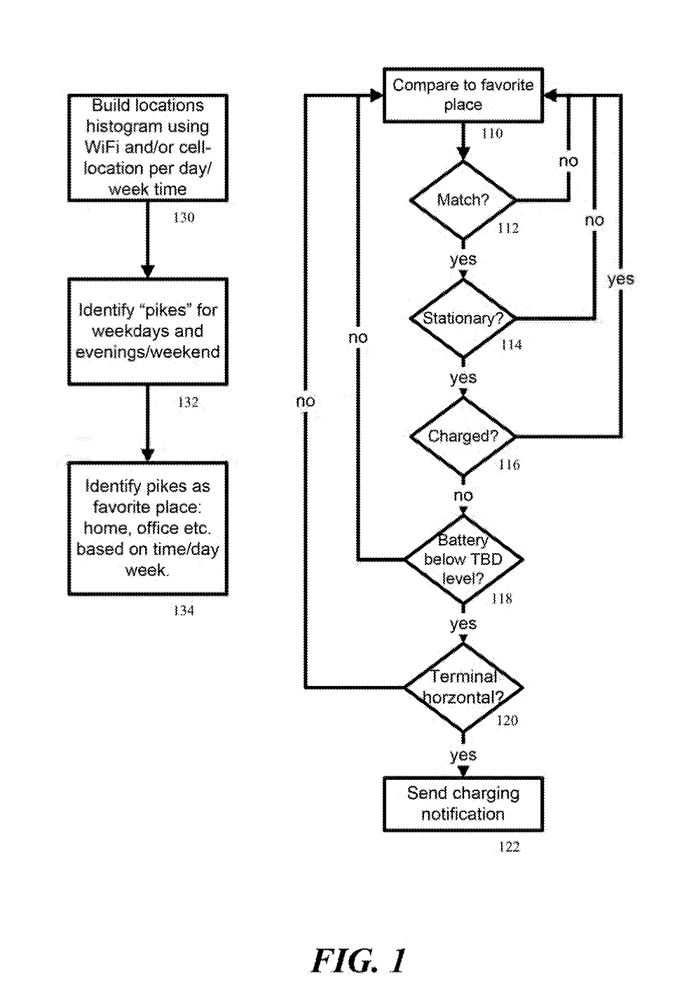

FIG. 1 shows a flow chart of a method for determining whether to send a charge alert the user of a mobile device according to one embodiment of the invention. The method can begin by using one or more location services (e.g., GPS, WiFi location services, wireless connection) to determine the location of the mobile device. If a location can be detected, the location can be compared to a list of favorite locations stored in memory of the mobile device at 110. The list of favorite locations can be a list or database of places where the mobile device has been previously charged. If the location does not match, the mobile device can periodically determine the mobile device location and compare the location with the list of favorites 110. If the location matches one of the favorites at 112, the next step can be to check one or more of the sensors or services available within the mobile device to determine whether the device is moving or stationary at 114. Mobile device mobility can, for example, be determined by access sensors, such as movement/orientation sensors or using location services to determine whether the location changes over a period of time. If the mobile device is not stationary, the mobile device can periodically determine the mobile device location and compare the location with the list of favorites 100. If the device is stationary, the mobile device can check the status of the battery at 116. If the battery is charged above a predefined level (e.g., greater than 75%), the mobile device can periodically determine the mobile device location and compare the location with the list of favorites 110. If the battery is below the predefined threshold, the mobile device can, optionally, determine whether the device is horizontal. Many mobile devices have sensors that determine the orientation of the device, so if the user is, for example, using the device, (e.g., the device is in a vertical orientation), instead of sending a charge alert, the mobile device can periodically determine the mobile device location and compare the location with the list of favorites 100. If the device is in a horizontal orientation or an orientation indicating that the device is not in use 120, the mobile device can send an alert to the user suggesting that the user charge the device.

In accordance with the various embodiments of the invention, the alert can be one or more indicators to the mobile device user, suggesting that the user connect the mobile device to a power source to charge the device. The alerts can include a pop-up message that appears on the screen of the device or a sound or tone that gets the attention of the user. The sound or tone can be audible message, such as “Charge Me” or “Please attach to power source.” In accordance with some embodiments, the alert can include a visual indicator as well as a sound. In accordance with some embodiment, the mobile device can send a message, such as an email message or a text message to a predefined address or phone number. The address or phone number can be determined based on the location of the device, for example, when the mobile device is located at the user's work it can send an email to the user's work email address and when the device is located at the user's home it can send an email the user's home email address. Similarly, the mobile device can call the user at their work phone or home phone and play pre-recorded message notifying the user to charge the mobile device. In addition, when the mobile device determines the location, it can check the user's address book or contacts on the device or at a remote location (e.g., a remote server) and place a phone call or send an email or text message to people in the user's address book asking them to remind the user to charge the mobile device. The charge alerts can include other types of messages, such as messages through social media services, such as Twitter and Facebook, notifying the user to charge their mobile device.

Further, the charge alerts can be provided by an alert service that is in communication with the user's mobile device. In this embodiment, the mobile device can send sensor and location information to a remote device or system that can analyze the data and send alerts to the user. The user can provide the alert service with a list of one or more ways to contact the user (e.g., by telephone, text message, SMS, email, voice mail) to alert the user to charge their mobile device. In this embodiment, the alert service use other information, not available to the mobile device, such as the mobile phone tower location as part of the analysis.

In element 110 above, the mobile device monitor's its location and periodically compares the location to a list of favorite locations. In accordance with some embodiments, the mobile device can monitor and store location information according to the time of day and day of the week to build a histogram or other representation of frequent and common locations where the user takes the mobile device at 130. The mobile device can analyze this data and identify frequent locations for weekdays, weekends and holidays at 132. Based on the time of day and the day of the week, the mobile device can automatically add some locations to the favorites list and make an informed estimate of which locations correspond to the user's home, work place and favorite places, like restaurants and shopping centers at 134. The device can also designate a location where the device was connected to a power source to be charged as a charging opportunity. In accordance with some embodiments, the mobile device can also access an external database, such as over a network that includes public locations where a user can charge a mobile device. This list can include airport locations, bus and train station locations, coffee shops and other public locations where the user can charge the mobile device. This external database can supplement the favorites list maintained by the mobile device or the alert service.

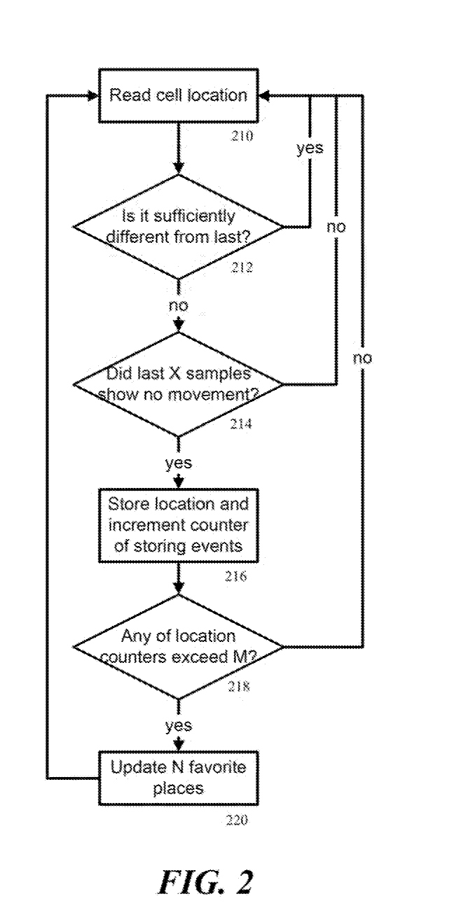

FIG. 2 shows a flow chart of a method for producing a favorite's list according to one embodiment of the invention. In accordance with an embodiment of the invention, the mobile device determines the location of the device at 210. The location can be determined using a cellular carrier provided location service (e.g., location based on available cell tower connections) or location can be determined by one or more services including GPS and WiFi location services. Location can also be determined based on a wireless connection, such as WiFi SSID and IP address. Some or all of these as well as other available location services can be used to determine the location of the mobile device. The present location can be stored in memory of the mobile device and compared to a prior location of the mobile device determine whether the difference between the locations is greater than a predefined threshold at 212. Where the mobile device has moved, e.g. the difference is greater than the predefined threshold, the mobile device can return to a loop that involves periodically determining the mobile device location, 210 and comparing it to a prior location 212. If the mobile device has not moved (e.g., the location differences are less than the threshold), the mobile device can determine whether the mobile device has been in essentially the same location for more than a predefined period of time (or number of location samples, X) at 214. If so, the mobile device can search its list or database to determine whether the location is in the list or database and increment a counter for that location at 216. The counter can be specific to the time of day (e.g. the hour or the morning, afternoon, evening, or night time periods) as well as the day of the week. The location is not found in the list or database, the location can be added to the list or database and the counter can be incremented at 216. The mobile device can also determine whether the counters for the location (or any other location) exceed a predefined threshold count, M at 218. If the location counter exceeds the threshold, the location can be designated as a favorite place and/or added to a list or database of favorite places at 220. Where the mobile device was charged at that location at a prior time, the list or database can identify or label the location as a charging opportunity and the charging opportunity label or attribute can be included in the favorites list or database.

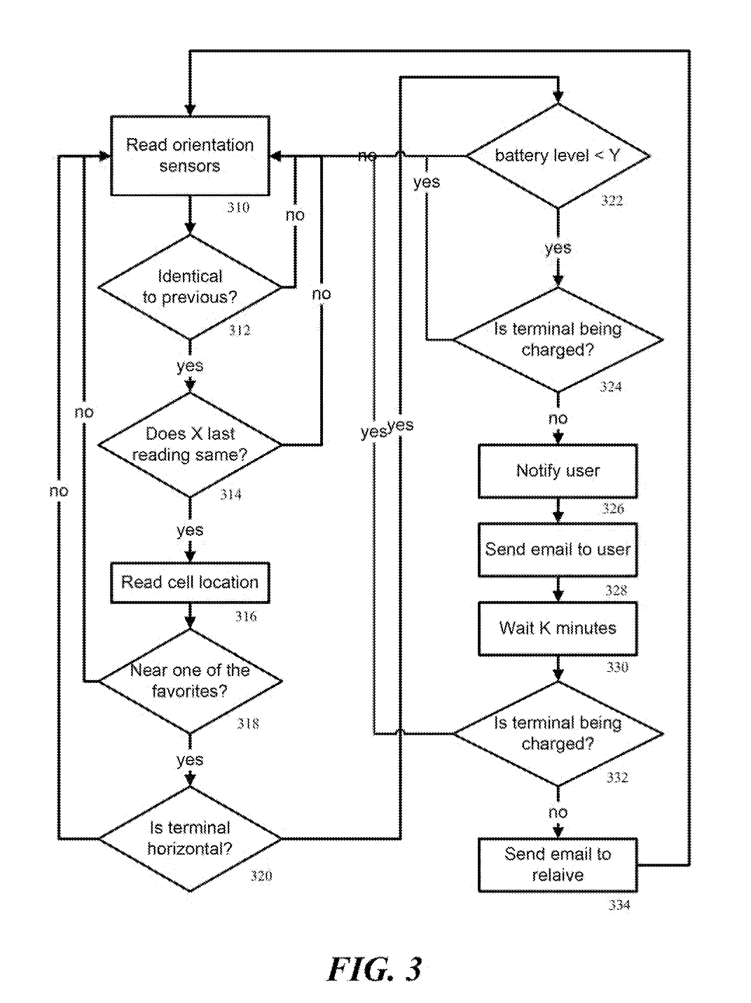

FIG. 3 shows a flow chart of a method for determining whether to send a charge alert the user of a mobile device according to an alternative embodiment of the invention. The mobile device can read its orientation sensor and determine the orientation of the mobile device at 310. The mobile device can compare the current orientation with a prior orientation to determine whether the orientation has changed at 312. The orientation has changed or has changed more than a predefined amount, the device can continue in a loop that include periodically checking the orientation sensor at 310 and determining if the orientation has not changed (e.g., the device is stationary) at 312. If the orientation has not changed over a predefined number of readings (“X”) at 314, the mobile device can determine its location as disclosed herein at 316. If the predefined number of readings (“X”) had not been reached the mobile device continues in the loop until the predefined number (“X”) is reached, indicating the device has been stationary for a predefined period of time. After determining the mobile device location 316, the location can be compared to the favorites list or database at 318 and if the mobile device is in a favorite location, the mobile device can determine whether device is not being used, for example, determine whether it is horizontal at 320. If the device is not near a favorite or being used (e.g., it is not horizontal), the mobile device can continue in the loop at 310. If the device is horizontal, the mobile device can check the battery level to determine whether the charge level is below a predefined threshold (“Y”) at 322. If the battery level is not below the predefined threshold (“Y”), the mobile device can continue in the loop at 310. If the battery level is below the predefined threshold (e.g., it could be charged) and the mobile device is not being charged at 324, the mobile device can send a charge alert to the user at 326. If the mobile device is being charged at 324, the mobile device can return to the loop at 310 or terminate the loop until the device is removed from the charger. After notifying the user at 326, the mobile device can send an email to the user at 328 and then wait a predefined period of time (“K”) and check to see whether the mobile device has been connected to a charger at 332. If the mobile device is connected to a charger, the mobile device can return to the loop at 310 or terminate the loop until the device is removed from the charger. If the mobile device is not connected to the charger, the mobile device can send an email to a relative at 334. The relative can be predetermined, such as ending it to a spouse or the relative can be determined based upon the location determined by the mobile device, the mobile device can look up the location is the user's address book or contact list and identify the email address of one or more relatives at the location to send an email to.

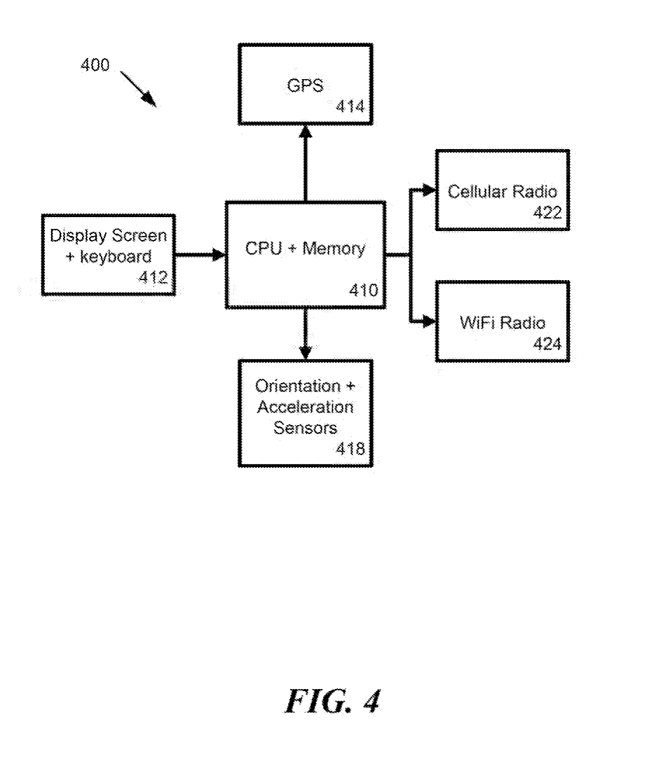

FIG. 4 shows a diagrammatic view of mobile device according to one embodiment of the invention. In this embodiment, the mobile device can be a cellular telephone 400 that includes one or more central processing units (CPU) and associated memories 410, operatively connected to a display screen and keyboard 412, a global positioning system sensor 414, orientation and/or acceleration sensors 418, a cellular radio 422 and WiFi radio 424. It is noted that in other embodiments, the CPU and associated memories can include many different types of controllers and many different types of memories. The memories can include both volatile and non-volatile memories and some of the memories can store computer programs that can be executed by the CPU. The GPS 414 can include all the necessary components to receive GPS signals and compute location or use one or more of the CPUs and associated memories to determine location using a computer program. Alternatively, received GPS signals can be sent over the cellular or WiFi networks to a remote system that determines location. The display screen and keyboard 412 can include a touch screen with a virtual keyboard that is displayed on the touch sensitive screen. The mobile device 400 can include a cellular radio 422 for connecting to one or more cellular networks (e.g., CDMA, 3G, 4G, etc) to transmit and receive voice and data. The mobile device 400 can include a WiFi radio 424 for connecting to wireless local area networks. Other radios can be provided to enable the mobile device 400 to connect to other wireless networks (e.g., Blue Tooth, WiMAX).

The mobile device 400 can determine location using any one or more of the following methods: 1) GPS, 2) Cell location, using triangulation between multiple base stations, 3) Cell location based on single cell site ID, 4) WiFi location, using WiFi access points with known locations as reference points, 5) IP locations: using known external IP assigned by location by ISP, 6) Identifying street address/business as described in U.S. Pat. No. 8,126,476, which is hereby incorporated by reference in its entirety, 7) Identifying street address/business as described in commonly owned U.S. patent application Ser. Nos. 12/549,784 and 12/907,959, each of which is hereby incorporated by reference in its entirety.

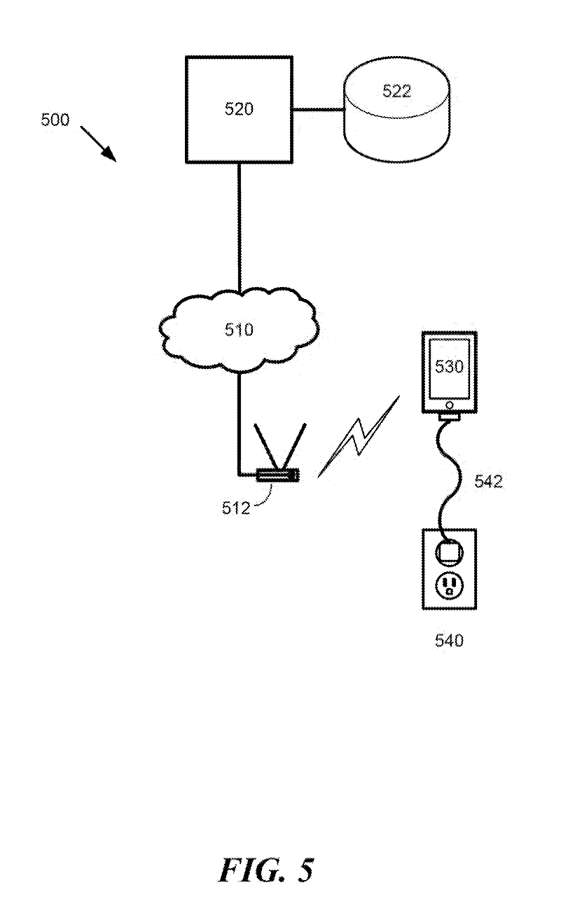

FIG. 5 is a diagrammatic view of a system according to some embodiments of the invention. In accordance with this embodiment, the system 500 can include a network station, such as a server 520 connected to a network 510. The network can include one or more wireless access points 512 that enable one or more mobile devices 530 to connect to the network to send data to and receive data from the server 520. The server 520 can include one or more databases 522 that enable the server to store data received from one or more mobile devices 530. In accordance with some embodiments, the server 520 can store information about charging opportunities provided by one or more of the mobile devices 530. Accordingly, as one or more mobile devices 530 determines that a location includes a charging opportunity, such as a place where the mobile device 530 can be charged, either because the device was charged at that location previously or the location is determined to be location where there is a high likelihood that charging is available (e.g., a home, office, airport or travel terminal location). In addition, the server 520 can send to the mobile device 530, the locations of charging opportunities (e.g., places stored in the database of server 520) for storage in the mobile device 530 memory. The location of charging locations can be downloaded in anticipation of travel, for example, the user can input a destination location and request the locations of all charging opportunities with a given distance of the destination location. Alternatively, the location of charging opportunities can be identified based on the present location of the mobile device 530 and its anticipated destination. Thus, a user traveling from the office toward a charging opportunity location in the server's database 522 can be notified of approaching charging opportunities. In this embodiment, the system can provide intelligent charging decisions by factoring the remaining battery charge in order to notify the user of a nearby or approaching charging opportunity and that there may not be enough energy in the battery to run the mobile device between the approaching charging opportunity and the next available charging opportunity. The database can also provide information about the location of the charging station, such as the type of location and other available facilities (e.g., a restaurant or coffee shop, the availability of food, mobile device service or repair, wireless internet access). Further, the invention can be modeled after or combined with systems that notify users of open or available WiFi hot spots. Such systems are disclosed in commonly owned U.S. patent application Ser. Nos. 11/441,827, 11/853,987, 11/968,073, 12,549,784, 12/907,959, 13/362,554, 13/400,056, 12/458,420 and 13/486,640 each of which is hereby incorporated by reference in its entirety.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A method for alerting a user to charge a battery of a mobile device, the method comprising:
determining a location of the mobile device;
searching a favorites list for the determined location; and
if the determined location is found in the favorites list, sending a charge alert to the user of the mobile device.

2. The method of claim 1 further comprising comparing the determined location with a prior determined location and if the difference between the determined location and the prior determined location is less than a predefined threshold and the determined location is found in the favorites list, sending a charge alert to the user of the mobile device.

3. The method of claim 1 further comprising determining a charge level of a battery in the mobile device and comparing the charge level with a predefined threshold charge level and if the charge level is below the predefined threshold charge level and the determined location is found in the favorites list, sending a charge alert to the user of the mobile device.

4. The method of claim 1 further comprising determining an orientation of the mobile device and if the mobile device is in a predefined orientation and the determined location is found in the favorites list, sending a charge alert to the user of the mobile device.

5. The method of claim 1 wherein the location of the mobile device is determined to be moving along a predefined route.

6. The method of claim 5 wherein the predetermined route is a road.

7. The method of claim 5 wherein the predetermined route is train tracks.

8. The method of claim 5 wherein the predetermined route is a boat route.

9. A method for determining at least one favorite charging location for a mobile device, the method comprising:
determining a location of the mobile device;
comparing the determined location of the mobile device with one or more prior locations of the mobile device;
if the determined location of the mobile device is substantially the same as one or more prior locations, incrementing a count for the location in the favorite location database and if the count exceeds a predefined count threshold, designating the location as a favorite location.

10. The method according to claim 9 wherein the mobile device is charging and the favorite location database is modified to indicate that the determined location is a charging opportunity.

11. The method according to claim 9 wherein determining the location of the mobile device includes receiving location data generated by the mobile device at a remote server and evaluating the location data at the remote server.

12. The method according to claim 9 wherein the mobile device generates location information as a function of at least one of cellular based location information, GPS location information, WiFi location information, and Terminal orientation information.

13. The method according to claim 9 further comprising determining whether the mobile device is not moving as function of at least one of mobile device location information, mobile device orientation information, and mobile device orientation information.

14. The method according to claim 9 further including monitoring the mobile device battery level by at least one of continuously measuring battery charge level, comparing a battery charge level to a pre-defined level, and estimating battery charge level when terminal will be connected to be charged.

15. The method according to claim 14 wherein:
battery level information is continuously measured over at least one mobile terminal;
determining battery discharge statistics; and
using the battery discharge statistics to determine discharge abnormalities.
